(19) United States
(12) Patent Application Publication
(10) Pub. No.: US 2012/0175544 A1
(43) Pub. Date: Jul. 12, 2012

(54) THERMOPLASTIC COMPOSITE BASED GATE VALVE

(75) Inventors: Stephen G. Leonard, Waterford, MI (US); Robert M. Zehnder, Shelby Township, MI (US)

(73) Assignee: U.S. FARATHANE CORPORATION, Auburn Hills, MI (US)

(21) Appl. No.: 13/348,686

(22) Filed: Jan. 12, 2012

Related U.S. Application Data
(60) Provisional application No. 61/431,979, filed on Jan. 12, 2011.

(51) Int. Cl. F16K 3/30

(52) U.S. Cl. 251/329; 251/366

(57) ABSTRACT

A displaceable valve body incorporated into a housing including a rigid thermoplastic body including suspended within the housing by a vertically displaceable stem associated with a solenoid. A softer thermoplastic material is applied in perimeter extending fashion to an exterior of the first material for sealing the valve when displaced to an interrupting position established between inlet and outlet locations communicating with the valve housing and, in the lowered position, a lower and arcuate configured edge of the body seals the interior of the valve housing. The solenoid is mounted atop the housing and communicates with the body via an interiorly/vertically translating stem in order to selectively lift and lower the body relative to a through flow interior established within the housing.

### CROSS REFERENCE TO RELATED APPLICATIONS

This application claims the benefit of Provisional Patent Application No. 61/431,979 filed Jan. 12, 2011.

### FIELD OF THE INVENTION

The present invention discloses a thermoplastic gate valve constructed of a two piece split shell and defining a lighter weight than that which is associated with heavier ferris oxide based gate seats and which are often coated within a thermoset outer rubber with separate side extending nylon guides. The proposed design substitutes the heavier iron endo skeleton of the prior art with a pair of thermoplastic formed and assembleable split portions (or halves), each incorporating a first main thermoplastic composite. Upon assembly, exterior facing sides of the fir composite exhibit receiving locations upon which is injected a second perimeter extending and TPE or other softer based thermo material and which exhibits high line bond strength with the main thermo composition. In use, the gate valve body is actuated (lifted and lowered) by a solenoid, such arrangement placing a premium on weight savings. It is also envisioned that the thermoplastic seating body associated with the reconfigured gate valve design is capable of application to any other valve design not limited to butterfly, check or ball valves, as well as combining of the outer conduit housing with the inner seal.

### DESCRIPTION OF THE PRIOR ART

The prior art is documented with examples of gate and other valve type arrangements. In one known design, a ferris oxide based gate seat is coated within a thermoset outer rubber with separate side extending nylon guides which coact with the inner hollowed architecture of the valve housing in actuating between closed and open positions for selectively permitting or interrupting fluid flow between inlet and outlet locations communicating with the valve housing. An example of such a known gate valve is depicted in U.S. Pat. No. 6,942,194 and includes a sealing insert within a flow area associated with an interior of the valve housing and a sliding insert element, such as exhibiting a metal core coated with an elastic, vulcanized rubber, cooperating with a contact area of the sealing insert in a closed state.

### SUMMARY OF THE PRESENT INVENTION

The present invention discloses a displaceable body incorporated into a valve housing including a body constructed from a first thermoplastic material, such as a rigid composite and including a support location associated with an upper edge for suspending the body from a vertically displaceable stem. A second softer thermoplastic material (such as a TPE) is applied in perimeter extending fashion to at least one exterior facing surface associated with the first material for sealing the valve when displaced to an interrupting position established between inlet and outlet locations communicating with the valve housing.

The body in one variant is constructed from first and second split portions such as which are assembled by a sonic welding process. The body further includes a lower and arcuate configured edge for sealing the interior of the gate valve housing. The body further includes a pair of laterally projecting and guiding wings and can incorporate a lubricious compound to facilitate guided displacement between the opened and closed positions associated with the housing interior. Each of the split portions further include inner pluralities of strengthening ribs to provide strength while significantly reducing overall weight.

A top of the body includes a recessed seating location for receiving an end portion associated with a vertically actuated solenoid assembly extends vertically through an interior of the valve housing. An upper projecting/actuating solenoid is mounted atop the housing and communicates with the body via an interiorly/vertically translating stem in order to selectively lift and lower the body relative to a through flow interior established within the housing.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of a composite gate valve including a rigid thermoplastic substrate compound and upon which is applied an engineered thermoplastic elastomer produced according to a two shot injection molding process and exhibiting high line bond strength;

FIG. 2 is an illustration of a first split shell half of the rigid substrate compound, prior to application of the outer TPE, and illustrating the guide surfaces upon which the second TPE elastomer is applied;

FIG. 3 is a rotated illustration of the split shell in FIG. 2 following application of the exterior TPE material and illustrating its inner skeletal and material/weight saving configuration;

FIG. 4 is a plan view illustration in partial cutaway and illustrating a solenoid actuating gate valve incorporating an inner seating and displaceable thermoplastic composite seal; and

FIG. 5 is a further rotated and cutaway view of the gate seal of FIG. 4.

### DETAILED DESCRIPTION OF THE PREFERRED EMBODIMENTS

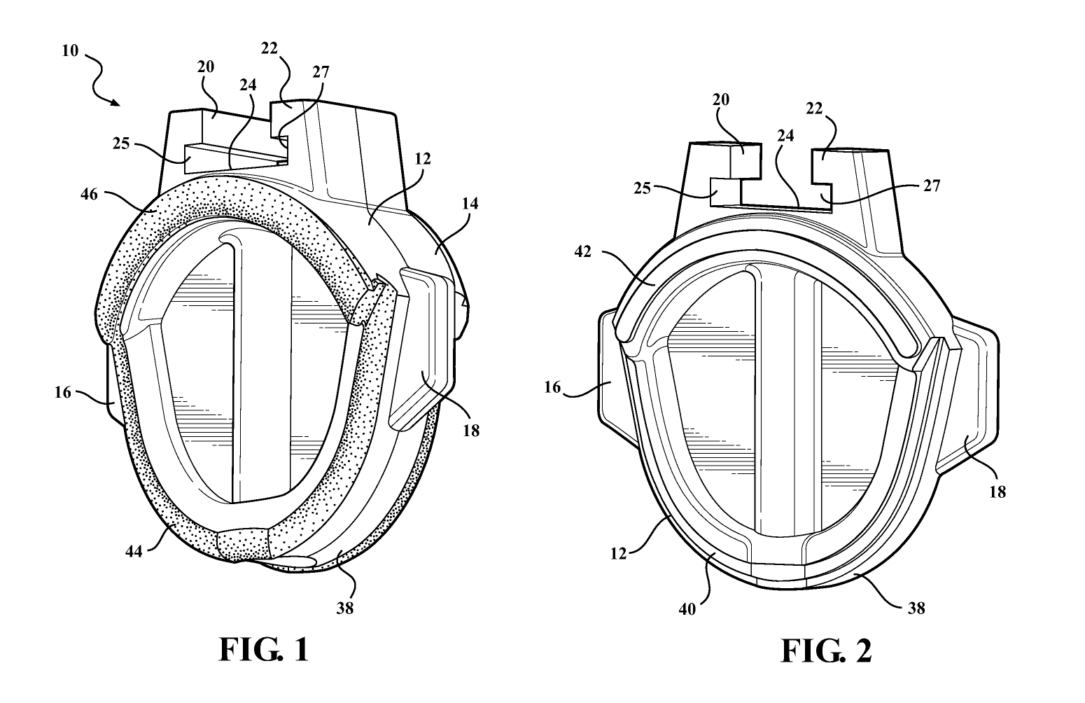

Referring now to the several illustrations, and initially to FIG. 1, the present invention discloses a thermoplastic gate valve, see as generally shown at 10 in FIG. 1, which provides a lighter weight displaceable body, such as constructed of a two piece split shell, in comparison to that which is associated with heavier ferris oxide based gate seats according to the prior art and which, as previously described, are often coated within a thermoset outer rubber with separate side extending nylon guides.

Specifically, the perspective illustration of the composite gate valve generally depicted at 10 in FIG. 1 includes a rigid thermoplastic substrate compound (composite), such as which is illustrated by substantially identical split shell portions (or halves) 12 and 14 in depiction of the individual split shell body portions which are produced according to any of an injection molding or other suitable thermoforming process. The thermoplastic material defining each of the split portions 12 and 14 may further incorporate a lubricious compound to reduce instances of sticking or jamming within the valve housing, such as in compensation for its lighter weight. Although not shown, the separately produced halves 12 and 14 are assembled in any desired fashion, such as including the provision of sonic welding, adhesives, mechanical fasteners or the like.

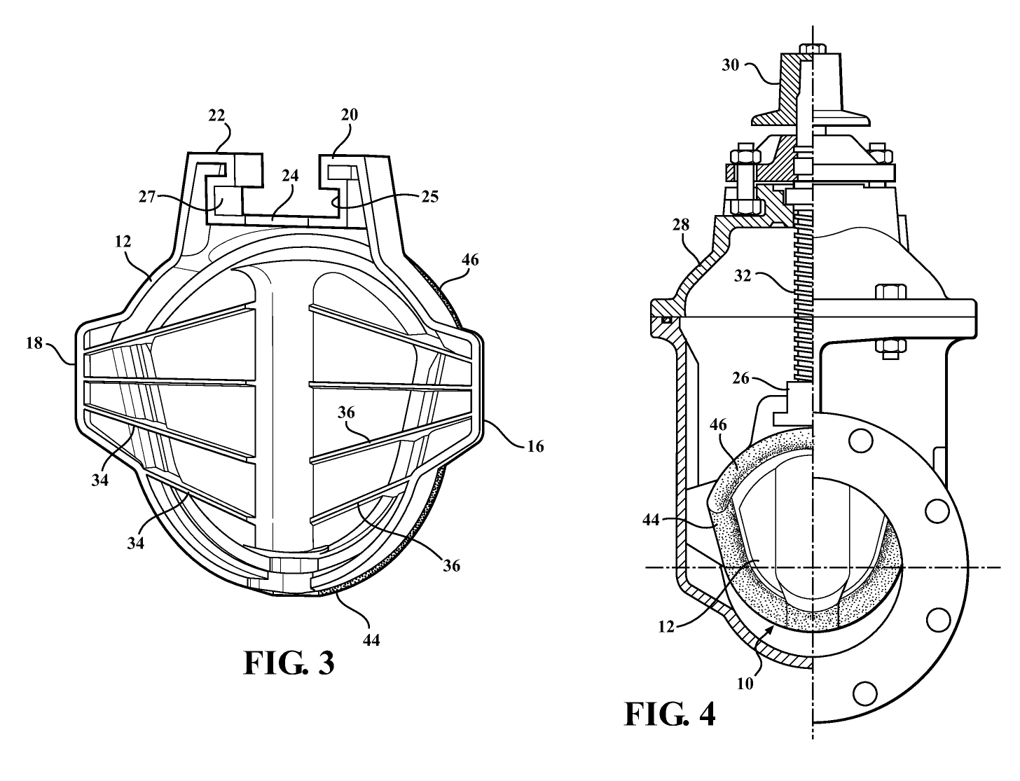

As additionally depicted in the first and second rotated views of FIGS. 2 and 3, selected split shell (half) 12 exhibits a generally rounded body generally dimensioned for displacing from a first elevation position to a second lowered/seating position in which the assembled body interrupts the flow of fluid through the valve housing. Each split shell further exhibits a pair of lateral seating or guide wings, see at 16 and 18 for selected split shell 12, these seating within mating configured locations (not shown) defined within the interior of the valve housing and in order to facilitate the unimpeded up/down actuating motion of the valve body 10.

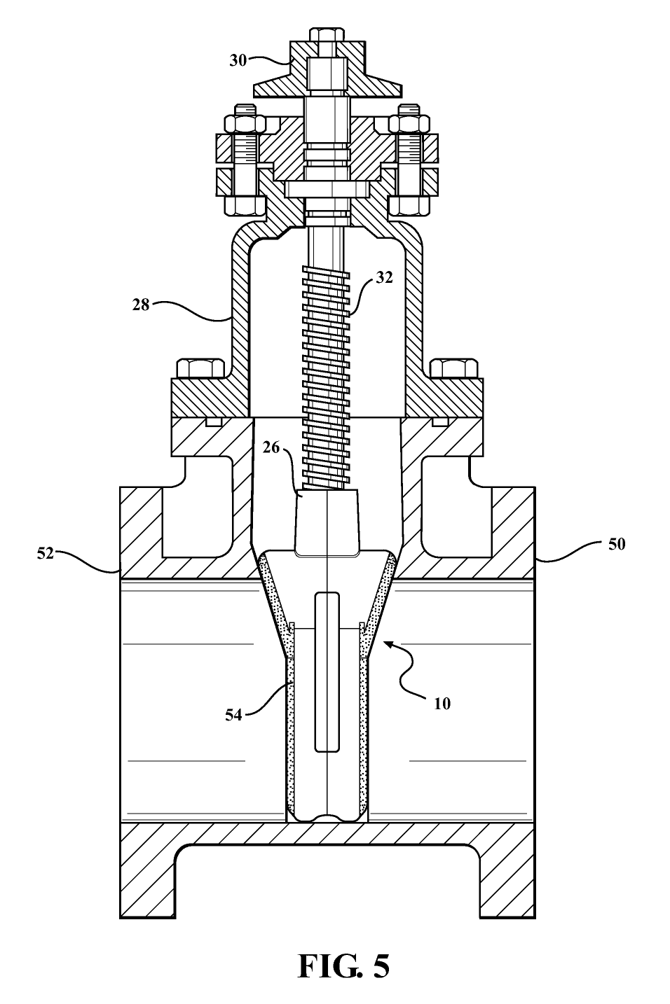

A top of each split shell thermoplastic composite body further exhibits a recessed/enlarged seating location, see uppermost and inwardly opposing portions 20 and 22 again associated with selected split shell 12 which define a narrowed neck therebetween which communicate to an enlarged inner profile (see base surface 24 and interconnected sides 25 and 27). An end portion 26 (see FIGS. 4 and 5) associated with a vertically actuated solenoid assembly extends vertically through an interior of an outer gate valve housing, further depicted at 28. An upper projecting/actuating solenoid 30 is mounted atop the housing 28 and communicates with the gate valve body 10 via interiorly/vertically translating stem 32 (again FIGS. 4 and 5) and in order to selectively lift and lower the body 10 relative to the through flow interior established within the housing 28.

As further shown in FIG. 3, a material and weight saving aspect associated with the thermoplastic construction of each split shell is depicted by inner pluralities of inner strengthening ribs, as exemplary illustrated at 34 and 36, and which establish a partially hollow interior to each inner facing side of the split halves 12 and 14 (see again FIG. 3) while also providing strength to each of the split half portions 12 and 14 following sonic welded or other suitable assembly while significantly reducing overall weight. Each of the split halves also depicting a lower and arcuate configured edge (see at 38 for selected split shell 12 in FIGS. 1 and 2) for sealing the interior of the gate valve housing 28 as again better depicted in FIG. 4.

As further shown in FIG. 2, a series of arcuate and perimeter edge communicating and interconnecting guide surfaces 40 and 42 are provided and upon which are applied an engineered thermoplastic elastomer, such as produced according to a two shot injection molding process. The second thermoplastic material is depicted in FIG. 1 as elongated and arcuate or bent extending overlays 44 and 46, each of which exhibits an additional arcuate profile when viewed in cross section such that they overlays are mechanically or chemically secured along their flattened undersides upon the template defining and underside guide surfaces 40 and 42.

In addition to the illustrated variant in which the three dimensional extending arcuate pattern associated with the overlays 44 and 46 are mounted in an edge to edge interconnecting arrangement, additional envisioned variants can include a single perimeter (or ring shaped) extending outer three dimensional seal or gasket, as well as other potential shapes or patterns which exhibit a rounded or other non-linear arcuate profile combined with an elongated shape and which again includes any type of suitable thermoplastic elastomer (TPE), such further exhibiting a softer consistence for providing enhanced and consistent edge extending sealing characteristics when seated in a given biasing fashion within the associated inner seating surfaces of the valve housing interior.

The secondary TPE or other softer thermoplastic material further establishes a high line bond strength when applied over the primary and split shell defined rigid thermoplastic composite in the manner shown. As further best shown in FIG. 1, the outer TPE or other softer thermoplastic material is applied to an exterior surface of each split shell half 12 and 14.

FIG. 4 again presents an end view illustration in partial cutaway of a solenoid actuating gate valve incorporating an inner seating and displaceable thermoplastic composite sealing body displaceably mounted to an end of the vertically extending and solenoid supported stem 32. Finally, FIG. 5 is a further rotated and cutaway view of the gate seal of FIG. 4. and exhibiting the housing 28 installed between inlet 50 and outlet 52 locations of the associated fluid line. Also depicted in side cutaway is a receiving/seating portion 54 pre-positioned within the flow through interior between the inlet 50 and outlet 52 and which receives the vertically actuating valve body 10.

Having described our invention, other and additional preferred embodiments will become apparent to those skilled in the art to which it pertains and without deviating from the scope of the appended claims. Specifically, the two shot thermoplastic and light weight valve body can incorporate a broad range of chemistries, applied to both the composite and TPE components, and such as which eliminates many of the production steps associated with the formation of a thermoset rubber around a ductile or cast iron valve seat.

As alluded to throughout the disclosure, advantages associated with the two shot thermoplastic valve seating body include the provision of lighter weight (thus allowing for the design of less robust solenoid actuators). The use of thermoplastic materials (such as in lieu of ferris oxide) further serves to prevent corrosion over prolonged use and the further ability to precisely position and form the second shot TPE geometry associated with perimeter extending portions 44 and 46 provides consistent sealing for establishing reliable shutoff, as well as overcoming the prior art issues of both bonding and dimensional tolerances required between the ferrous and rubber components associated with conventional valve seats. In this fashion, improvement in the precise material volume and zone of sealing (established by portions 44 and 46) assist in contributing to the lower overall weight of the displaceable body.

We claim:

1. A displaceable body incorporated into a valve housing, comprising:
a body constructed from a first thermoplastic material and including a support location associated with an upper edge for suspending said body from a vertically displaceable stem; and
a second softer thermoplastic material applied in perimeter extending fashion to at least one exterior facing surface associated with said first material for sealing the valve when displaced to an interrupting position established between inlet and outlet locations communicating with the valve housing.

2. The invention as described in claim 1, said body further comprising first and second split portions which are assembled by a sonic welding process.

3. The invention as described in claim 1, said body further comprising a pair of laterally projecting and guiding wings.

4. The invention as described in claim 1, further comprising a lubricious compound incorporated into said body.

5. The invention as described in claim 1, a top of said body further comprising a recessed seating location for receiving an end portion associated with a vertically actuated solenoid assembly extends vertically through an interior of the valve housing.

6. The invention as described in claim 5, further comprising an upper projecting/actuating solenoid mounted atop the housing and communicating with said body via an interiorly/vertically translating stem in order to selectively lift and lower said body relative to a through flow interior established within the housing.

7. The invention as described in claim 2, each of said split portions further comprising inner pluralities of strengthening ribs to provide strength while significantly reducing overall weight.

8. The invention as described in claim 1, said body further comprising a lower and arcuate configured edge for sealing the interior of the gate valve housing.

9. The invention as described in claim 1, said first thermoplastic material further comprising a rigid composite.

10. The invention as described in claim 1, said second thermoplastic material further comprising at least a TPE material.

11. A gate valve, comprising:
a three dimensional shaped body constructed from first and second split portions, each of which further comprising a partially hollow interior defined by inner pluralities of strengthening ribs, said body being displaceably mounted between first and second vertically movable positions within an associated housing;
said body being constructed from a first thermoplastic material and including a support location associated with an upper edge for suspending said body from a vertically displaceable stem projecting through a top of said housing and which is operated by a solenoid assembly; and
a second softer thermoplastic material applied in perimeter extending fashion to at least one exterior facing surface associated with said first material for sealing the valve when displaced to an interrupting position established between inlet and outlet locations communicating with the valve housing.

12. The invention as described in claim 11, said body further comprising a pair of laterally projecting and guiding wings.

13. The invention as described in claim 11, further comprising a lubricious compound incorporated into said body.

14. The invention as described in claim 11, a top of said body further comprising a recessed seating location for receiving an end portion associated with said vertically actuated solenoid assembly extending vertically through an interior of said valve housing.

15. The invention as described in claim 11, said body further comprising a lower and arcuate configured edge for sealing the interior of the gate valve housing.

16. The invention as described in claim 11, said first thermoplastic material further comprising a rigid composite.

17. The invention as described in claim 1, said second thermoplastic material further comprising at least a TPE material.

18. A gate valve, comprising:
a three dimensional shaped body constructed from first and second split portions, each of which further comprising a partially hollow interior defined by inner pluralities of strengthening ribs, said body further comprising a pair of laterally projecting and guiding wings and, upon said split portions being engaged together, said body being displaceably mounted between first and second vertically movable positions within an associated housing;
said body being constructed from a first thermoplastic and rigid composite elastomer material and including a support location associated with an upper edge for suspending said body from a vertically displaceable stem projecting through a top of said housing and which is operated by a solenoid assembly; and
a second softer thermoplastic material applied in perimeter extending fashion to at least one exterior facing surface associated with said first material for sealing the valve when displaced to an interrupting position established between inlet and outlet locations communicating with the valve housing.
